(19) United States
(12) Patent Application Publication
(10) Pub. No.: US 2004/0076705 A1
(43) Pub. Date: Apr. 22, 2004

(54) Apparatus for conveying ceramic moldings

(75) Inventors: Satoshi Ishikawa, Anjo-city (JP); Hiromi Katou, Kuwana-city (JP); Shoichi Goto, Nagoya-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, AICHI-PREF. (JP)

(21) Appl. No.: 10/674,502

(22) Filed: Oct. 1, 2003

(30) Foreign Application Priority Data
Oct. 22, 2002 (JP) 2002-307490

(51) Int. Cl. B28B 13/04

(52) U.S. Cl. 425/315; 425/309

(57) ABSTRACT

The present invention relates to a conveying apparatus for guiding a rod-like ceramic molding, continuously extruded from a mold and extending from the mold while not yet cut, to a cutter for cutting the rod-like ceramic molding into ceramic blocks, each having a predetermined length. The conveying apparatus has pads, each having a placement surface for placing the rod-like ceramic molding while being in contact with the outer circumference of the rod-like ceramic molding, and the placement surface of the pad has an axial length shorter than a half of an axial length of the ceramic block to be cut by the cutter.

### BACKGROUND OF THE INVENTION

1. Field of the Invention

The present invention relates to an apparatus for conveying ceramic moldings obtained by extrusion molding.

2. Description of the Related Art

In the prior art, there is a horizontal extrusion molding process as one of methods for extruding ceramic moldings. According to this process, a mold is provided at a tip end of an extruder disposed in a horizontal direction (a lateral direction), and ceramic material is continuously introduced into the extruder and extruded from the mold as a continuous rod-like ceramic molding. This continuous rod-like ceramic molding is cut into pieces of a predetermined length to become ceramic blocks. The ceramic blocks are subjected to various processes including a drying process or a calcination process to result in one or more finished ceramic moldings.

In this regard, the rod-like ceramic molding immediately after being extrusion-molded is very soft and weak and easily deformable. To produce the finished ceramic molding good in quality, it is necessary to hold and convey the rod-like ceramic molding immediately after being extrusion-molded without it being deformed.

An apparatus for conveying the rod-like ceramic molding obtained by the extrusion mold has been known, in which a rail of a recessed cross-section is disposed adjacent to a mold of an extruder, and air is ejected from the inner circumference of the rail onto the rod-like ceramic molding during the conveyance to hold the same, while it floats, above the inner circumference of the rail. According to this conveying apparatus, it is possible to immediately place the rod-like ceramic molding, continuously extruded from the mold, on the rail disposed adjacent to the mold.

However, there is a problem in the above-mentioned conventional conveying apparatus as described below.

That is, when the rod-like ceramic molding immediately after being extrusion-molded is soft and weak, there is a risk in that the rod-like ceramic molding may deform due to the air stream itself ejected from the inner circumference of the rail.

Particularly, in a case of a ceramic molding of a honeycomb structure which has recently been used as a catalyst carrier of an exhaust gas cleaner for an automobile, a cell wall forming a honeycomb structure or a skin on the outer circumference thereof is made thin to realize a high cleaning performance. Thereby, the rod-like ceramic molding for manufacturing the final ceramic molding is extremely soft and weak and liable to be easily deformed by the air stream ejected from the inner circumference of the rail.

On the other hand, another conveying system can be adopted in which the rod-like ceramic molding is placed on a pad during the conveyance. In such a case, each of the pads is also used for holding thereon one ceramic block cut thereafter. As the rod-like ceramic molding of a length longer than an axial length of the pad is extruded, this length of the ceramic molding is sequentially placed on the pad which then advances in synchronism with an extrusion molding speed.

However, in this conveying apparatus, it is impossible to set a new pad until a gap exceeding a length of the pad in the conveying direction is formed between the mold and the preceding pad on which the rod-like ceramic molding is placed.

Accordingly, the rod-like ceramic molding which has freshly been extruded from the mold but is not yet placed on the pad sags due to its own weight between the mold and the preceding pad. Thereby, when the rod-like ceramic molding extruded from the mold is newly placed on the pad, the former is not parallel to a placement surface of the pad. In this regard, the rod-like ceramic molding is solely brought into contact with the placement surface of the pad at a forward end of the pad as seen in the conveying direction.

Thus, the weight of a portion of the rod-like ceramic molding extruded from the mold but not yet placed on the pad is applied to the contact point of the pad with the rod-like ceramic molding. When this weight is large, there may be a risk in that a deformation occurs in the rod-like ceramic molding.

In this regard, if it is possible to store the pad directly beneath an extrusion screw in advance and advance the pad in synchronism with the extrusion of the rod-like ceramic molding from the mold, the above-mentioned problem would not occur. However, as there is no space for storing the pad beneath the extrusion screw in the conventional extruder, this countermeasure is not practical.

### SUMMARY OF THE INVENTION

The present invention has been made to solve the above problems in the prior art by providing an apparatus for conveying a rod-like extruded ceramic molding, without the deformation thereof.

The present invention is a conveying apparatus for guiding a rod-like ceramic molding, continuously extruded from a mold and extending from the mold while not yet cut, to a cutter for cutting the rod-like ceramic molding into ceramic blocks, each having a predetermined length, wherein

the conveying apparatus has pads, each having a placement surface for placing the rod-like ceramic molding while being in contact with the outer circumference of the rod-like ceramic molding, and the placement surface of the pad has an axial length shorter than a half of an axial length of the ceramic block to be cut by the cutter, and

a portion of the rod-like ceramic molding to be cut off as the ceramic block is held and conveyed by two of the pads or more.

According to the inventive conveying apparatus, the axial length of the pad is shorter than a half of the axial length of the ceramic block. The portion of the rod-like ceramic molding to be cut off as the ceramic block is held by two of the pads or more.

Thereby, according to the above-mentioned pads, the rod-like ceramic molding having the axial length shorter than the axial length of the ceramic block is sequentially placed thereon. That is, at an instant when the axial length of the rod-like ceramic molding newly extruded from the mold exceeds the axial length of the pad which is shorter than a half of the axial length of the ceramic block, the rod-like ceramic molding is sequentially placed on the pad.

Thus, when the extruded rod-like ceramic molding is newly placed on the pad, it is possible to shorten the extruded length from the mold and reduce the weight of this portion. That is, when the rod-like ceramic molding is freshly placed on the pad, the force applied between the pad and the rod-like ceramic molding is reduced.

Thus, according to the inventive conveying apparatus, it is possible prevent the rod-like ceramic molding from deforming due to the excessive contact pressure between the placement surface of the pad and the outer circumference of the rod-like ceramic molding extruded from the mold while somewhat sagging.

In this regard, according to the present invention, a magnitude of the contact pressure between the rod-like ceramic molding extending from the mold while somewhat sagging and the pad is adjustable in accordance with the axial length of the pad.

That is, the axial length of the pad is preferably adjusted so that the deformation of the rod-like ceramic molding does not occur due to the excessive contact pressure. If the rod-like ceramic molding is even softer and weaker, the axial length of the pad may be further reduced to avoid the deformation of the rod-like ceramic molding.

In the first invention, the ceramic block is preferably capable of providing two or more of final ceramic moldings.

In this case, the axial length of the ceramic block becomes longer. When a portion of the rod-like ceramic molding cut off as the ceramic block is placed on one pad, it is impossible to set a new pad unless a longer distance is ensured between the mold and the preceding pad.

Accordingly, the weight of the portion of the rod-like ceramic molding extruded from the mold but not yet being placed on the pad becomes larger, whereby the contact pressure between the pad and the rod-like ceramic molding becomes larger when this portion is placed on the pad. Thus, the risk is further increased in that the rod-like ceramic molding may deform upon the placement on the pad.

Thus, when two or more of the final ceramic moldings are cut off from one ceramic block, the effect of the present invention is particularly significant, and is obtained by placing the ceramic block on the plurality of pads.

Also, the pad on which the rod-like ceramic molding is placed is preferably adapted to advance in the extruding direction at a speed generally equal to the extrusion-molding speed of the rod-like ceramic molding.

In this case, there is no frictional resistance between the rod-like ceramic molding and the pad. Thereby, a risk of the deformation in the rod-like ceramic molding becomes less during the conveyance thereof on the pad.

Also, the portion to be cut off is preferably held by the same number of pads as the final moldings cut off from the ceramic block.

In this case, it is possible to carry out a series of processes initiating from the drying, calcination and ending to the cutting-off of the final ceramic molding while maintaining the rod-like ceramic molding on the pads.

In this regard, a portion of the rod-like ceramic molding to be cut off as one final ceramic molding may be held by a plurality of pads. In such a case, the cutting-off operation of the final ceramic molding can be carried out while placing the rod-like ceramic molding on the pads and the rod-like ceramic molding extruded from the mold can be further assuredly prevented from deforming when the same is placed on a fresh pad.

At least the placement surface of the pad is preferably formed of low resilience material easily deformable in conformity with the contour of the rod-like ceramic molding when being in contact with the latter.

The low resilience material is a material capable of maintaining the contour of the soft and weak ceramic molding.

If the placement surface is formed of the low resilience material, the placement surface is deformable in conformity with the outer circumference of the rod-like ceramic molding.

Accordingly, it is possible to increase the contact area of the placement surface with the rod-like ceramic molding and to reduce the contact pressure between them. Thus, a risk of deformation of the rod-like ceramic molding placed on the pad is further reduced.

The low resilience material is preferably a foamed material selected from a group of urethane, melamine, Teflon and silicon.

In this case, it is possible to manufacture the pad at a high efficiency, having the above-mentioned placement surface due to the excellent moldability of the foamed material obtained from urethane, melamine, Teflon or silicon.

Also, if the placement surface is formed of the above-mentioned foamed material, the evaporation of the moisture from the outer circumference of the ceramic block to outside is not disturbed. Thereby, it is possible to dry the ceramic block or the rod-like ceramic molding while placing the same on the pads.

The placement surface preferably has a cross-section, taken along a plane vertical to the axial direction, in conformity with a cross-section of the rod-like ceramic molding, taken along a plane vertical to the axial direction.

In such a case, since the contact area of the placement surface with the outer circumference of the rod-like ceramic molding increases, the contact pressure per unit area becomes smaller. Thus, a risk of the deformation of the conveyed rod-like ceramic molding placed on the pad is further reduced.

The ceramic molding is preferably of a honeycomb structure having cells formed so that cell walls are arranged in a honeycomb manner.

In such a case, the cell wall arranged in a honeycomb manner is liable to be strained, to deform the ceramic molding. Therefore, the present invention is especially effective.

The conveying apparatus preferably comprises a rotary roller and a belt adapted to advance by the rotary roller, and the pad is bonded to a conveyor surface of the belt for conveying the rod-like ceramic molding.

In such a case, it is possible to sequentially supply the rod-like ceramic molding extruded from the mold to the pad and place the same thereon by the conveying apparatus of a relatively simple structure. That is, as the belt advances, the pads bonded to the conveyor surface of the belt are sequentially fed to support the rod-like ceramic molding.

The present invention may be more fully understood from the description of the preferred embodiments of the present invention, as set forth below, together with the accompanying drawings.

### BRIEF DESCRIPTION OF THE DRAWINGS

In the drawings:

FIG. 1 is an illustration of an apparatus for conveying ceramic moldings according to a first embodiment of the present invention;

FIG. 2 is a sectional view of an extruder in the first embodiment;

FIG. 3 is a side view of a conveying apparatus in the first embodiment;

FIG. 4 is a top view of the conveying apparatus in the first embodiment;

FIG. 5 is a front view of a pad in the first embodiment;

FIG. 6 is an illustration for explaining a cutter in the first embodiment;

FIG. 7 is a perspective view of a ceramic molding in the first embodiment;

FIG. 8 is an illustration for explaining a conveying apparatus in a second embodiment;

FIG. 9 is an illustration for explaining the placement of a rod-like ceramic molding onto a pad having a small axial length in a comparative example;

FIG. 10 is an illustration for explaining the placement of a rod-like ceramic molding onto a pad having a large axial length in the comparative example;

FIG. 11 is a sectional view illustrating a honeycomb structure in the interior of a ceramic block cut from the rod-like ceramic molding placed on the pad having a small axial length; and

FIG. 12 is a sectional view illustrating a honeycomb structure in the interior of a ceramic block cut from the rod-like ceramic molding placed on the pad having a large axial length.

### DESCRIPTION OF THE PREFERRED EMBODIMENTS

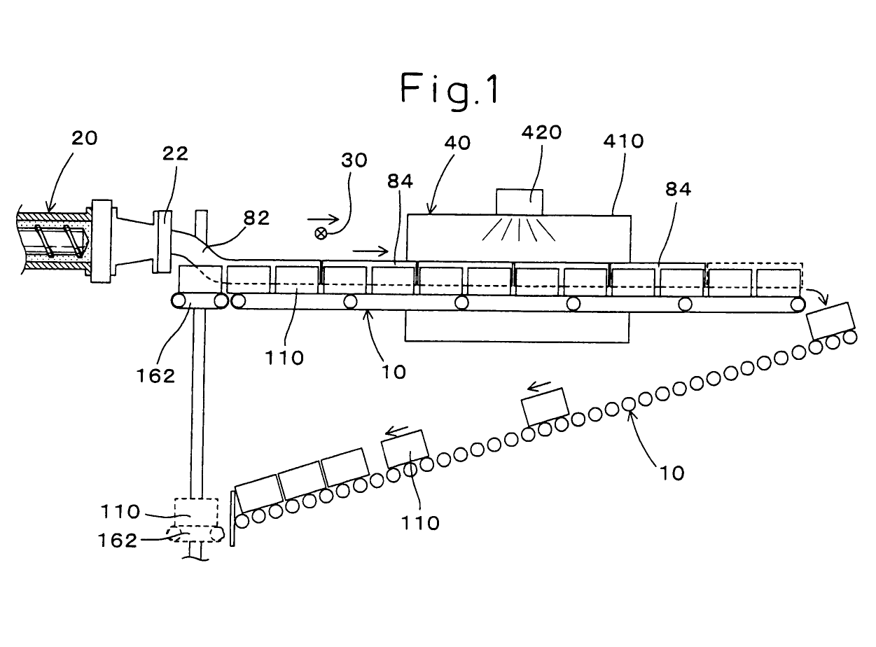

With reference to FIGS. 1 to 7, an apparatus for conveying ceramic moldings of the present invention will be explained. Initially, a first embodiment will be described below.

This embodiment relates to a conveying apparatus 10 for guiding a non-cut rod-like ceramic molding 82 continuously extrusion-molded from a mold 22 and extending from the mold 22 to a cutter 30 in which the rod-like ceramic molding 82 is cut to be ceramic blocks 84, as shown in FIG. 1.

The conveying apparatus 10 has a plurality of pads 110, each provided with a placement surface to be brought into contact with the outer circumference of the rod-like ceramic molding 82 and place the same thereon. The placement surface of the pad 110 has a length less than a half of an axial length of the ceramic block 84 to be cut from the rod-like ceramic molding 82 in the cutter 30.

It is arranged that the respective portion in the rod-like ceramic molding 82 to be cut into the ceramic block 84 is supported and conveyed by two pads 110 or more.

In this regard, the explanation will be made, in more detail, below.

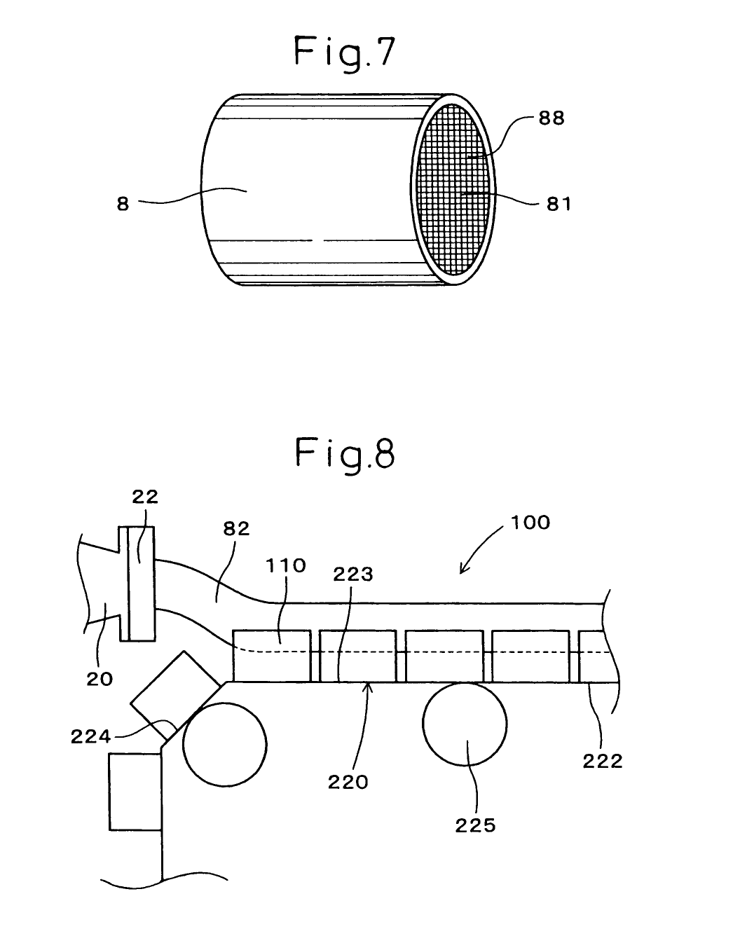

A final extruded ceramic molding 8 in this embodiment is a honeycomb structure as shown in FIG. 7 used as a catalyst carrier of an exhaust gas cleaner for an automobile.

The ceramic molding 8 of a honeycomb structure has a number of cells 88 sectioned by ceramic partitioning walls 81 and is shaped to be generally cylindrical.

Especially, as shown in FIG. 7, the ceramic molding 8 in this embodiment is of a cylindrical form of 110 mm in diameter and has a wall thickness, of the partitioning wall 81, as small as 75 μm for the purpose of restricting the resistance, by the honeycomb molding, to the flowing exhaust gas. Also, the axial length of the ceramic molding 8 is 200 mm.

As shown in FIG. 1, an apparatus 1 for producing the ceramic molding 8 in this embodiment includes an extrusion-molding device 20 for extrusion-molding the rod-like ceramic molding 82 of a honeycomb structure, a conveying apparatus 10 for conveying the rod-like ceramic molding 82, a cutter 30 for cutting the rod-like ceramic molding 82 thus conveyed into ceramic blocks 84, and a drying device 40 for drying the ceramic blocks 84. The above-mentioned apparatus 1 further includes a calcination device (not illustrated) for calcining the dried ceramic blocks 84 and a cutting-off device (not illustrated) for cutting off the final ceramic molding.

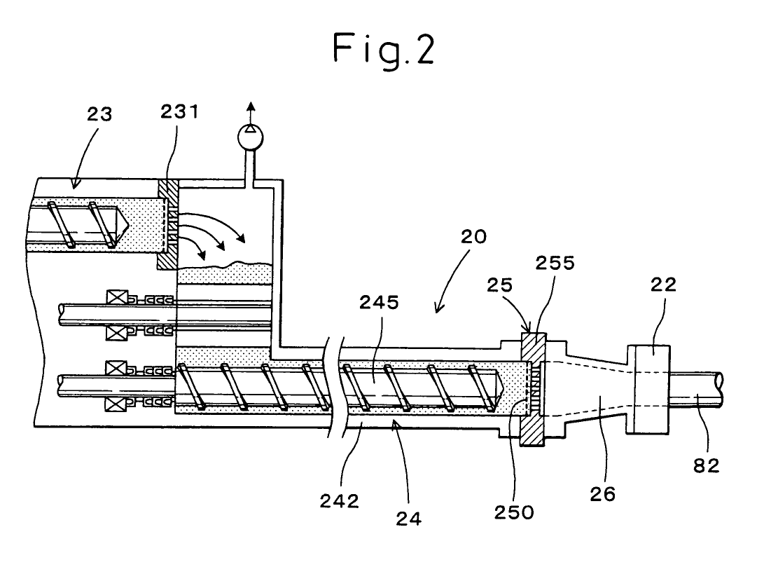

As shown in FIG. 2, in a lower part of the extrusion-molding device 20, there are a mold 22 for extrusion-molding ceramic material 80, a screw extruder 24 for supplying the ceramic material 80 to the mold 22, and a filter device 25 for filtrating the ceramic material 80 at an exit of the screw extruder 25.

As shown in FIG. 2, the mold 22 is used for molding the ceramic material 80 supplied from the screw extruder 24 into the rod-like ceramic molding 82. Between the mold 22 and the screw extruder 24, there is a resistance tube 26 having a hollow section of a generally circular cross-section and an inner diameter gradually decreasing from the screw extruder 24 to the mold 22.

As shown in FIG. 2, the filter device 25 consists of a filter net 250 and a support 255 for supporting the former. The support 255 is a member made of metal and has a number of through-holes for allowing the ceramic material 80 to pass therethrough. The filter net 250 is made by knitting a thin wire of stainless steel to form a plurality of small meshes.

As shown in FIG. 2, in the screw extruder 24, an extrusion screw 245 is provided in a hollow space in a screw housing 242.

The extrusion screw 245 has a single pressurizing lead of a spiral form on the outer circumference of a rotary screw shaft. The pressurizing lead is adapted to advance the ceramic material 80 to the mold 22 while pressing and kneading the latter.

As shown in FIG. 2, the screw housing 242 has a hollow cylindrical space for accommodating the extrusion screw 245. To an end of the screw housing 242 in the extruding direction of the screw housing 242, the filter device 25, the resist tube 26 and the mold 22 are coupled to the hollow cylindrical space.

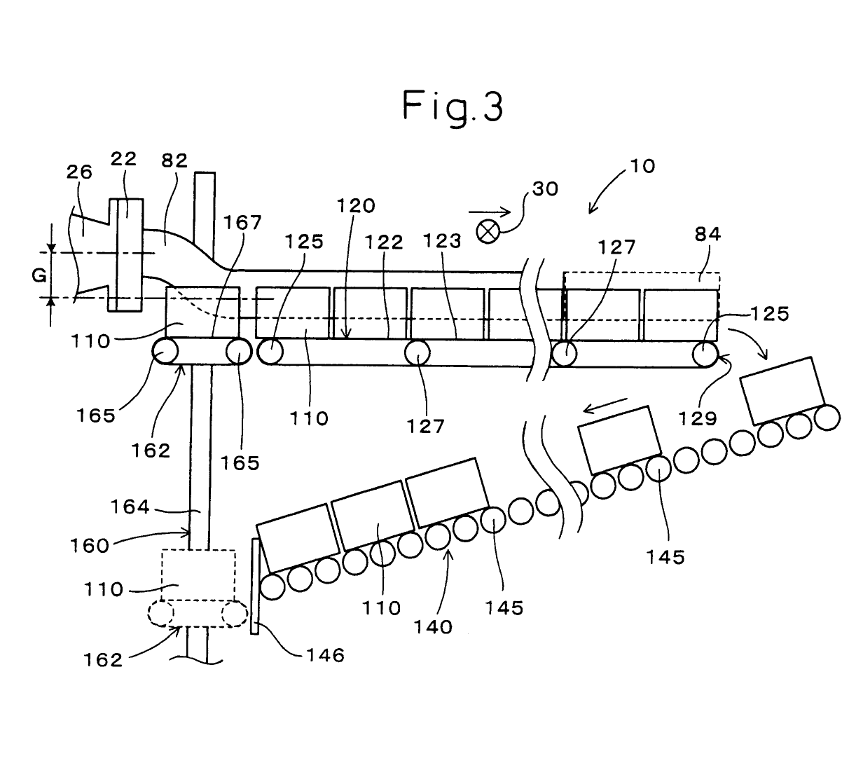

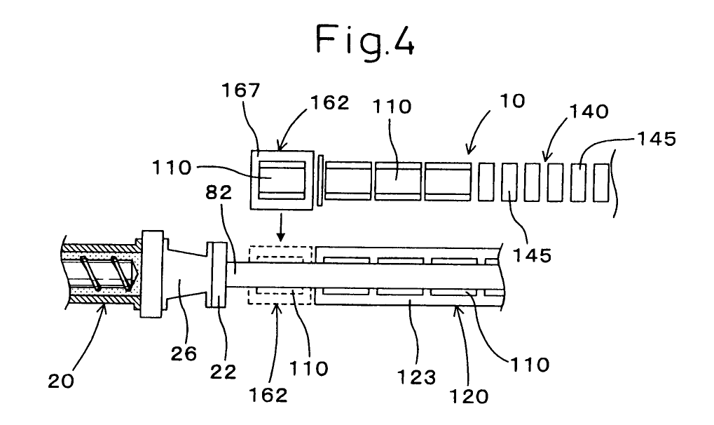

As shown in FIGS. 3 and 4, the conveying apparatus includes pads 110 for placing the rod-like ceramic molding 82 thereon, a conveyor 120 for advancing the pads 110 in the extruding direction, a recovery rail 140 for recovering empty pads from a post process, and an elevator 160 for returning the recovered pads 110 to the conveyor 120.

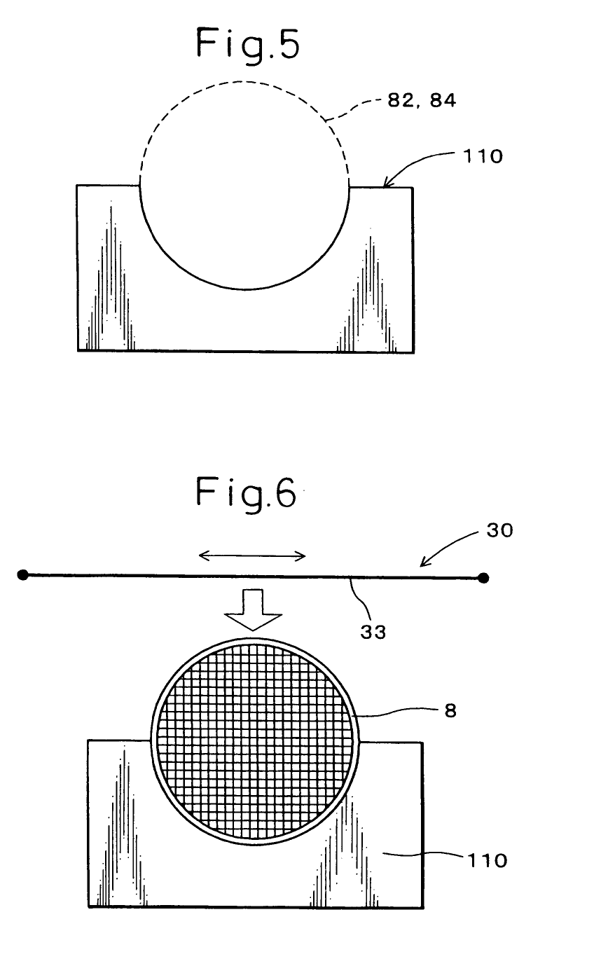

As shown in FIG. 5, the pad 110 has a recessed cross-section complementary to the outer circumference of the rod-like ceramic molding 82 or the ceramic block 84. The pad 110 is made of low resilience material such as a sponge of polyurethane resin. In this embodiment, the axial length of the pad 110 is 160 mm.

In this regard, the reason why the spongy material is used is that the dissipation of moisture contained in the ceramic block 84 is not disturbed in the drying device 40 described later. Also, the reason why the cross-sectional shape of the pad 110 is made to be complementary to the outer circumference of the rod-like ceramic molding 82 or the ceramic block 84 is that a contact area with the rod-like ceramic molding 82 or others increases to restrict the rise of contact pressure so that the deformation of the rod-like ceramic molding 82 or others is avoidable.

The pad 110 may be made of other material than the above, provided the temperature rise due to the microwave heating is lower than that of the ceramic block 84 itself. More concretely, the pad 110 is suitably made of material having a loss factor (a product of dielectric constant and tangent delta) lower than that of the ceramic material 80 to the microwaves. Since the temperature rise is more suppressed during the microwave heating as the loss factor is smaller, it is possible to maintain the pad 110 at a lower temperature than the temperature of the ceramic block 84.

Resins other than the polyurethane resin used in this embodiment may be used such as melamine resin, Teflon (registered trade mark) resin, mica resin, alumina resin, polyethylene resin or silicon resin.

As shown in FIGS. 3 and 4, the above-mentioned conveyor 120 is disposed in the extruding direction generally parallel to the mold 22 of the extrusion-molding device 20 with a predetermined gap between one end of the conveyor and the mold 22 of the extrusion-molding device 20. In this embodiment, an axis of the rod-like ceramic molding 82 placed on the pads 110 on the conveyor 120 is located at a level lower in the vertical direction than an axis of the mold 22. This is because the rod-like ceramic molding 82 not yet placed on the pad 110 naturally sags (as shown in FIG. 3 by G) due to its own weight at the exit of the mold 22.

As shown in FIG. 1, the conveyor 120 is provided with the cutter 30 described later and with the drying device 40 at an end thereof. Further, a rear end of the conveyor 120 in the conveying direction is coupled to the recovery rail 140 described later so that empty pads 110 are fed to the recovery rail 140.

As shown in FIG. 3, this conveyor 120 has a loop-like endless belt 122 carrying the pads 110 thereon, two rotary rollers 125 disposed inside the endless belt 122 at axial opposite ends thereof, and a plurality of level rollers 127 for maintaining the belt horizontal.

As shown in FIG. 3, the rotary roller 125 has a drive shaft extending generally vertical to the extruding direction of the rod-like ceramic molding 82 and coupled to a motor not shown. The rotary roller 125 is adapted to transmit a torque of the motor to the belt 122. The belt 122 is adapted so that a conveyor surface 123 for placing and conveying the rod-like ceramic molding 82 is advanced in the extruding direction.

In this regard, the conveyor may be a roller type conveyor in which a placement surface is formed by a plurality of rotary rollers arranged parallel to each other in the conveying direction, other than the belt type conveyor 122 used in this embodiment.

An elevator 160 is disposed between the mold 22 of the extrusion-molding device 20 and the conveyor 120, for supplying the recovered empty pads 110 to the conveyor 120, as shown in FIG. 3. The elevator 160 includes an elevating section 162 movable obliquely and generally vertical to the conveying direction and a post 164 for raising and lowering the elevating section 162.

As shown in FIG. 3, the elevating section 162 has rotary rollers 165 generally parallel to the rotary rollers 125 of the conveyor 120, and the rotary roller 165 is driven by a motor not shown. A loop-like endless belt 167 is wrapped around the rotary rollers 165. The belt 167 is adapted to move by the torque of the rotary rollers 165.

As shown in FIGS. 3 and 4, the recovery rail 140 is a rail for recovering the empty pads 110 conveyed by the conveyor 120 and reaching an end thereof. That is, the ceramic blocks 84 are dried and solidified in the drying device 40 and recovered from the pads 110 to be introduced into the calcination device and the cutting-off device. The recovery rail 140 recovers the empty pads 110 fed from the conveyor 120 and delivers the same to the elevator 160.

As shown in FIGS. 3 and 4, the recovery rail 140 is a roller type conveyor including a plurality of rotary rollers 145, each having a horizontal rotary axis, disposed vertical to the direction from the end of the conveyor 120 and the elevator 160. This recovery rail 140 is adapted to form a slope descending from the end of the conveyor 120 to a lower portion of the elevator 160 so that the pads 110 are fed from the end of the conveyor 120 to the elevator 160 by the rotation of the rotary rollers 145 and gravity. At the end of the recovery rail 140 closer to the elevator 160, a stopper 146 is provided for stopping the pads 110.

As shown in FIG. 6, the cutter 30 has a cutter wire 33 and means (not shown) for moving the cutter wire 33 in the extruding direction of the rod-like ceramic molding 82. The rod-like ceramic molding 82 conveyed by the conveyor 120 is cut by the cutter 30 into the ceramic blocks 84, each having a predetermined axial length.

As shown in FIG. 6, the cutter wire 33 is tensioned in the horizontal direction as well as generally vertical to the axial direction of the rod-like ceramic molding 82. The cutting wire 33 descends in the vertical direction while repeating a reciprocation in the wire direction to cut the rod-like ceramic molding 82.

As shown in FIG. 3, the moving means is adapted to move the cutter wire 33 in the conveying direction of the rod-like ceramic molding 82 in synchronism with the conveying speed of the conveyor 120. Also, the moving means is adapted to return the cutter wire 33 to the initial position after the cutting operation has completed.

As shown in FIG. 1, the drying device 40 includes a duct 410 for covering the conveyor 120, and a microwave generator 420 for irradiating microwaves into the interior of the duct 410.

The microwaves are irradiated to the rod-like ceramic molding 82 conveyed by the conveyor 120 to suitably dry the same.

The calcination device not shown is adapted to calcine the dried rod-like ceramic molding 82.

The cutting-off device not shown includes a chuck for fixing the calcined ceramic block 84 and a cutter wire running substantially vertical to the axial direction of the chucked ceramic block 84. Thus, the cutter wire cuts the ceramic block 84 to complete the finished ceramic molding.

Next, a method for producing the ceramic molding 8 by using the apparatus 1 described above will be explained below.

As shown in FIG. 2, when the rod-like ceramic molding 82 is extruded by the extrusion-molding device 20 in this embodiment, the ceramic material 80 kneaded in the upper stage screw extruder 23 is introduced into the lower stage screw extruder 24 from the upstream thereof. The ceramic material 80 pressurized by the extrusion screw 245 advances to the mold 22.

As shown in FIG. 3, simultaneously with the arrival of a front end of the rod-like ceramic molding 82 extruded through the mold 22 in the vicinity of the end of the conveyor 120, the elevating section 162 of the elevator 160 carrying the pad 110 thereon ascends until the upper surface of the belt 167 is generally flush with the conveying surface 123 of the belt 122. And, a front end of the rod-like ceramic molding 82 is placed on the pad 110.

At this time, the motor not shown of the elevating section 162 starts the rotation to advance the belt 167 in the extruding direction. As the belt 167 advances, the pad 110 moves in the extruding direction. In synchronism with the extrusion-molding speed of the rod-like ceramic molding 82, the pad 110 moves from the elevating section 162 to the conveyor 120.

When the pad 110 has been transferred to the conveyor 120 as described above, the elevating section 162 descends along the post 164, and stops at a position at which the upper surface of the belt 167 in the elevating section 162 is lower than the upper surface of the recovery rail 140 adjacent to the stopper 146 (the elevating section 162 at this position is represented by a dotted line in FIG. 3).

At this time, the stopper 146 of the recovery rail 140 is released and, simultaneously therewith, the motor of the elevating section 162 rotates in reverse to move the belt 167 in reverse to the extruding direction. And, the pad 110 waiting on the recovery rail 140 moves toward the elevating section 162 and is placed on the upper surface of the belt 167 of the elevating section 162. Finally, the stopper 146 is closed.

The elevating section 162 carrying the pad 110 thereon is made to ascend again by the elevator 160 so that the upper surface of the belt 167 in the elevating section 162 is generally flush with the upper surface of the conveyor 120. Then, a body of the rod-like ceramic molding 82, a front end of which is held by another pad 110, is placed on the pad 110.

Simultaneously, the motor not shown of the elevating section 162 starts the rotation to advance the belt 167 in the extruding direction. As the belt 167 advances, the pad 110 moves in the extruding direction. This pad 110 moves from the elevating section 162 to the conveyor 120 in synchronism with the extrusion-molding speed. The pad 110 transferred to the conveyor 120 is placed on the belt 122 advancing in synchronism with the extrusion-molding speed and moves further forward.

In this embodiment, the supply of the pad 110 described above is continuously repeated by the elevator 160 in synchronism with the extrusion-molding of the rod-like ceramic molding 82 through the extrusion-molding device 20. The pad 110 is newly supplied as the rod-like ceramic molding 82, of a length generally coinciding with the axial length of the pad 110, is freshly extruded from the mold 22, to continuously hold the rod-like ceramic molding 82.

In this regard, the apparatus 1 of this embodiment is adapted to quickly supply the pad 110 by the elevator 160 in correspondence to the extrusion-molding speed of the rod-like ceramic molding 82 as high as 3 m/min. According to this embodiment, the pad 110 is supplied in synchronism with the extrusion-molding of the rod-like ceramic molding 82 so that a gap of approximately 20 mm is maintained between the adjacent two pads 110 on the conveyor 120.

Next, the cutter 30 cuts the rod-like ceramic molding 82 conveyed by the conveyor 120 into a plurality of ceramic blocks 82, each having a unit length. The cutter 30 is capable of cutting the rod-like ceramic molding 82 now being conveyed by the cutter wire 33 adapted to be movable in the extrusion-molding direction.

The ceramic block 84 is further conveyed by the conveyor 120 to be introduced into the duct 410 of the drying device 40. The ceramic block 84 is irradiated with microwaves generated by the microwave generator, and is dried and solidified by the dissipation of moisture contained therein.

The dried and solidified ceramic block 84 is removed from the pad 110 and introduced into the calcination device. The calcined ceramic block 84 is further conveyed to the cutting-off device. In the cutting-off device, the calcined ceramic blocks 84 are cut to be a predetermined number of ceramic moldings 8.

The empty pad 110 from which the dried ceramic block 84 is removed as described above is supplied from an exit 129 of the conveyor 120 to the recovery rail 140.

According to the apparatus 1 for conveying the ceramic molding 8 in this embodiment, part of the rod-like ceramic molding 82 cut off from the ceramic block 84 is supported by two pads 110 divided in the axial direction.

Thereby, in synchronism with the fresh extrusion of the rod-like ceramic molding 82 having a length generally equal to the axial length of the pad 110 from the mold 22, it is possible to place the extruded rod-like ceramic molding 82 on the pad 110.

Accordingly, in the conveying apparatus 1 of this embodiment, an extruded length of the rod-like ceramic molding 82 is made shorter when the rod-like ceramic molding 82 extruded from the mold 22 is freshly placed on the pad 110 to reduce the weight of this part. Thus, it is possible to reduce a force applied to the rod-like ceramic molding 82 from the placement surface of the pad 110 to mitigate the contact pressure between the two so that the deformation of the rod-like ceramic molding 82 is limited.

A ceramic molding of the honeycomb structure having a partitioning wall thickness of 150 μm or less, including the ceramic molding 8 of this embodiment having a partitioning wall thickness of 75 μm, is very soft and weak. In such a ceramic molding, as the deformation is particularly liable to be generated when placed on the pad after being extruded, the conveying apparatus 1 in this embodiment is especially effective.

In this regard, one ceramic molding 8 may be cut off from the ceramic block 84 of this embodiment. That is, when the partitioning wall 81 of the ceramic molding 8 is further thinned, there is a risk in that the deformation of the rod-like ceramic molding 82 occurs even if the axial length of the ceramic block 84 is short. Therefore, it is effective to divide the pad 110 in the axial direction as in the conveying apparatus of this embodiment.

Further, a rotary device may be provided between the cutter and the drying device, for changing the posture of the ceramic block 84 in the vertical direction to transfer the ceramic block 84 to a pad for vertical placement, after which it is introduced into the drying device enlarged in height. In this case, the weight of the ceramic block 84 during the conveyance or drying acts in the axial direction wherein the ceramic block 84 has a larger strength.

Also, in place of the drying device 40 in this embodiment, the above-mentioned rotary device may be provided. In such a case, it is possible to introduce the ceramic molding 8 changed its posture in the vertical direction and placed on the pad for the vertical placement into a drying device disposed separately from the conveying apparatus 1.

Next, a second embodiment of the present invention will be described below.

In the second embodiment, a method for supplying the pad is changed while using a conveying apparatus based on that used in the first embodiment.

As shown in FIG. 8, according to a conveying apparatus 100 in the second embodiment, a belt 222 of a conveyor 220 is formed by joining a plurality of generally flat conveyor plates 224 together, each being larger than a bottom surface of the pad 110, in the conveying direction. To a conveyor surface 223, which is a surface of the conveyor plate 224, one pad 110 is bonded. Also, it is adapted to advance the belt 222 of the conveyor 220 in the extruding direction by the rotation of a rotary roller 225.

The rod-like ceramic molding 82 continuously extruded from the mold 22 is placed on the pad 110 bonded to the conveyor surface 223.

According to the conveying apparatus 100 of this embodiment, the operation and effect of the present invention is achievable by a relatively simple structure. That is, as the belt 222 advances, the pads 110 bonded to the conveyor surface 223 of the belt 222 are sequentially fed to place the rod-like ceramic molding 82 thereon.

In this regard, the other structures, the operation and the effect are the same as in the first embodiment.

Then, a comparative example will be described below.

In this comparative example, the influence of the axial length of the pad on the honeycomb structure in the interior of the rod-like ceramic molding was studied based on the conveying apparatus used in the first embodiment.

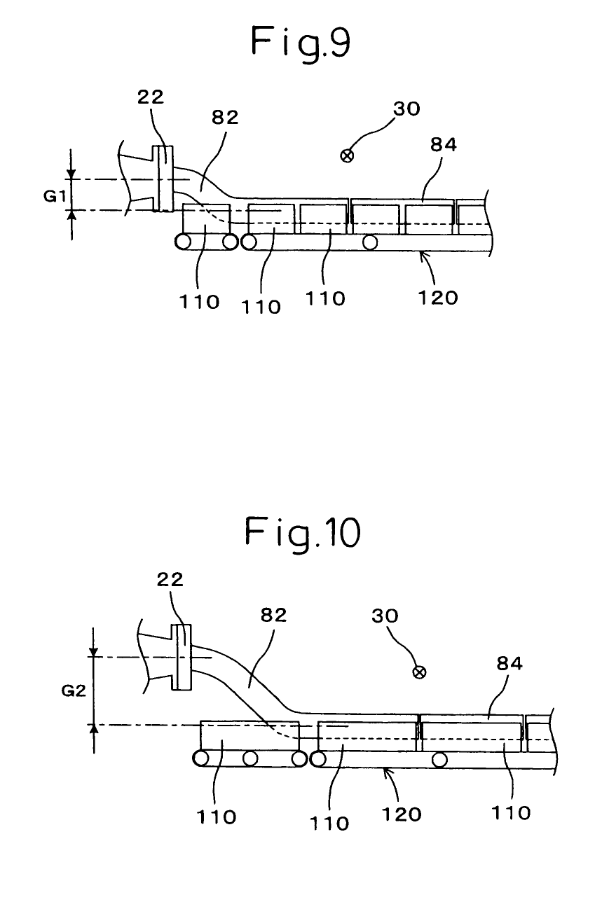

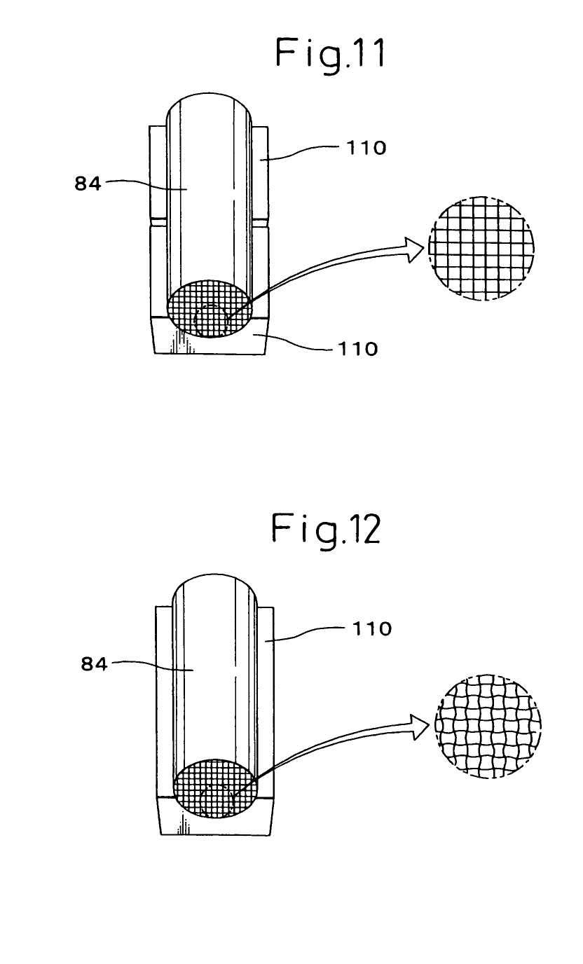

In this comparative example, the difference, between the honeycomb structure in the interior of the rod-like ceramic molding 82 placed on the pad 110 having a shorter axial length shown in FIGS. 9 and 11 and the honeycomb structure in the interior of the rod-like ceramic molding 82 placed on the pad 110 having a longer axial length shown in FIGS. 10 and 12, was investigated.

As a result, it was found that as the axial length of the pad 110 becomes longer, an amount of sag of the rod-like ceramic molding extending from the mold 22 to the pad 110 becomes larger.

That is, an amount of sag G2 when the axial length of the pad 110 is longer is larger, as shown in FIG. 10, than an amount of sag G1 when the axial length of the pad 110 is shorter, as shown in FIG. 9.

Also, as shown in FIGS. 11 and 12, it was found that there is a difference in a cross-section of the ceramic block 84 in the vicinity of a front end surface as seen in the conveying direction between the pads 110 having different axial lengths.

That is, as shown in FIG. 11, in the ceramic block 84 cut-off from the rod-like ceramic molding 82 placed on the pad 110 having a shorter axial length, the honeycomb structure is hardly deformed. On the other hand, as shown in FIG. 12, in the ceramic block 84 cut-off from the rod-like ceramic molding 82 placed on the pad 110 having a longer axial length, the partitioning walls 81 forming the honeycomb structure are strained to deform the cells 88.

In this regard, as shown in FIGS. 11 and 12, an end of the ceramic block 84 was cut-off after being dried and the honeycomb structure of the cross-section was observed. This is because the cross-section obtained by cutting the soft rod-like ceramic molding 82 or the soft ceramic block 84 prior to the drying may often be deformed due to the cutting operation, which disturbs the proper comparison.

Based on these facts, the following conclusion was drawn. As the axial length of the pad 110 becomes longer, the weight of the rod-like ceramic molding extending from the mold 22 becomes larger and an amount of sag thereof, from the mold 22, is larger.

A contact pressure between the placement surface of the pad 110 and the rod-like ceramic molding 82 is proportional to the weight of the rod-like ceramic molding 82 extruded from the mold 22. If the contact pressure is large, there is a risk of the deformation of the honeycomb structure in the interior of the rod-like ceramic molding 82.

As described above, to convey the rod-like ceramic molding 82 without generating deformation, it is effective to sequentially place the rod-like ceramic molding 82 extruded from the mold 22 on the pad 110 having a shorter axial length. That is, by using the pad 110 having a shorter axial length, it is possible to restrict the contact pressure between the rod-like ceramic molding 82 and the placement surface of the pad 110 and to eliminate the deformation of the interior of the rod-like ceramic molding 82.

In this regard, the other structures of this comparative example are the same as the first embodiment.

While the invention has been described by reference to specific embodiments chosen for the purpose of illustration, it should be apparent that numerous modifications could be made thereto by those skilled in the art without departing from the basic concept and scope of the invention.

What is claimed is:

1. A conveying apparatus for guiding a rod-like ceramic molding, continuously extruded from a mold and extending from the mold while not yet cut, to a cutter for cutting the rod-like ceramic molding into ceramic blocks, each having a predetermined length, wherein
the conveying apparatus has pads, each having a placement surface for placing the rod-like ceramic molding while being in contact with the outer circumference of the rod-like ceramic molding, and the placement surface of the pad has an axial length shorter than a half of an axial length of the ceramic block to be cut by the cutter, and
a portion of the rod-like ceramic molding to be cut off as the ceramic block is held and conveyed by two or more of the pads.

2. A conveying apparatus for guiding a ceramic molding as defined by claim 1, wherein the ceramic block is capable of providing two or more of final ceramic molding.

3. A conveying apparatus for guiding a ceramic molding as defined by claim 1 or 2, wherein the pad on which the rod-like ceramic molding is placed is adapted to advance in the extruding direction at a speed generally equal to the extrusion-molding speed of the rod-like ceramic molding.

4. A conveying apparatus for guiding a ceramic molding as defined by claim 1, wherein the portion to be cut off is held by the same number of pads as the final moldings cut off from the ceramic block.

5. A conveying apparatus for guiding a ceramic molding as defined by claim 1, wherein at least the placement surface of the pad is formed of low resilience material easily deformable in conformity with the contour of the rod-like ceramic molding when being in contact with the latter.

6. A conveying apparatus for guiding a ceramic molding as defined by claim 5, wherein the low resilience material is a foamed material selected from a group of urethane, melamine, Teflon and silicon.

7. A conveying apparatus for guiding a ceramic molding as defined by claim 1, wherein the placement surface has a cross-section taken along a plane vertical to the axial direction is in conformity with a cross-section of the rod-like ceramic molding taken along a plane vertical to the axial direction.

8. A conveying apparatus for guiding a ceramic molding as defined by claim 1, wherein the ceramic molding is of a honeycomb structure having cells formed so that cell walls are arranged in a honeycomb manner.

9. A conveying apparatus for guiding a ceramic molding as defined by claim 1, wherein the conveying apparatus comprises a rotary roller and a belt adapted to advance by the rotary roller, and the pad is bonded to a conveyor surface of the belt for conveying the rod-like ceramic molding.
This listing of claims will replace all prior versions, and listings, of claims in the application:

1. (original) A conveying apparatus for guiding a rod-like ceramic molding, continuously extruded from a mold and extending from the mold while not yet cut, to a cutter for cutting the rod-like ceramic molding into ceramic blocks, each having a predetermined length, wherein
the conveying apparatus has pads, each having a placement surface for placing the rod-like ceramic molding while being in contact with the outer circumference of the rod-like ceramic molding, and the placement surface of the pad has an axial length shorter than a half of an axial length of the ceramic block to be cut by the cutter, and
a portion of the rod-like ceramic molding to be cut off as the ceramic block is held and conveyed by two or more of the pads.

2. (original) A conveying apparatus for guiding a ceramic molding as defined by claim 1, wherein the ceramic block is capable of providing two or more of final ceramic molding.

3. (currently amended) A conveying apparatus for guiding a ceramic molding as defined by claim 12, wherein the pad on which the rod-like ceramic molding is placed is adapted to advance in the extruding direction at a speed generally equal to the extrusion-molding speed of the rod-like ceramic molding.

4. (original) A conveying apparatus for guiding a ceramic molding as defined by claim 1, wherein the portion to be cut off is held by the same number of pads as the final moldings cut off from the ceramic block.

5. (original) A conveying apparatus for guiding a ceramic molding as defined by claim 1, wherein at least the placement surface of the pad is formed of low resilience material easily deformable in conformity with the contour of the rod-like ceramic molding when being in contact with the latter.

6. (original) A conveying apparatus for guiding a ceramic molding as defined by claim 5, wherein the low resilience material is a foamed material selected from a group of urethane, melamine, Teflon and silicon.

7. (original) A conveying apparatus for guiding a ceramic molding as defined by claim 1, wherein the placement surface has a cross-section taken along a plane vertical to the axial direction is in conformity with a cross-section of the rod-like ceramic molding taken along a plane vertical to the axial direction.

8. (original) A conveying apparatus for guiding a ceramic molding as defined by claim 1, wherein the ceramic molding is of a honeycomb structure having cells formed so that cell walls are arranged in a honeycomb manner.

9. (original) A conveying apparatus for guiding a ceramic molding as defined by claim 1, wherein the conveying apparatus comprises a rotary roller and a belt adapted to advance by the rotary roller, and the pad is bonded to a conveyor surface of the belt for conveying the rod-like ceramic molding.
